(19) United States
(12) Patent Application Publication
(10) Pub. No.: US 2006/0001898 A1
(43) Pub. Date: Jan. 5, 2006

(54) Image printing apparatus and display device and job processing method therefor

(75) Inventors: Toshiyuki Maeshima, Tokyo (JP); Minoru Yaguchi, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA BUSINESS TECHNOLOGIES, INC., Tokyo (JP)

(21) Appl. No.: 10/963,923

(22) Filed: Oct. 12, 2004

(30) Foreign Application Priority Data
Jul. 2, 2004 (JP) 2004-196313
Jul. 2, 2004 (JP) 2004-196314

(51) Int. Cl. G06F 15/00

(52) U.S. Cl. 358/1.14; 358/1.15

(57) ABSTRACT

There is provided an image printing apparatus which can ensure confidentiality by including an identification section which identifies whether or not a user who requests a job is present in a predetermined range from the image printing apparatus, a queue which stores the job and manages an execution of the job in stored order, a job registration section which registers the job at the end of the queue, and a job management section which suspends the start of execution of the job registered in the queue when the identification section does not recognize the presence of the user who requests the job, and permits the start of execution of the job registered in the queue when the identification section recognizes the presence of the user who manages the job. A display device and a job processing method are also provided.

### FIELD OF THE INVENTION

The present invention relates to an image printing apparatus such as a printer or multifunction apparatus and, more particularly, to an image printing apparatus which executes print jobs for printed matter with high confidentiality in reservation order on the basis of the identification of a user, and a display device and job processing method for the apparatus.

### BACKGROUND OF THE INVENTION

An image printing apparatus such as a digital multifunction apparatus which can reserve a plurality of jobs is generally designed to register a submitted job at the end of a queue and sequentially process jobs from the job at the head of the queue.

An image printing apparatus which allows the priority of an output to be temporarily increased in case of emergency is disclosed in, for example, Japanese Unexamined Patent Publication No. 11-27438.

An apparatus having a confidential printing function is available, which prevents, when a remote terminal apparatus such as a personal computer generates a print request with high confidentiality, printed matter from being output before a user who manages the job arrives at the image printing apparatus so as to prevent others from seeing it. In confidential printing, a job corresponding to a print request and print data are temporarily stored, and printing is started under the condition that a print instruction containing the password of the user who manages the job is input again through the operation section of the image printing apparatus.

In addition, an image printing apparatus which can identify a user in a short period of time with a small amount of work by using radio communication between the image printing apparatus and a portable terminal such as a cellular phone set is disclosed in, for example, Japanese Unexamined Patent Publication No. 2003-94777.

Assume that a given user reserves a print job for a document with high confidentiality by using an image printing apparatus without any confidential printing function under the circumstance where the apparatus is shared by a plurality of users. In this case, in order to prevent others from seeing the document, the user must stay in front of the image printing apparatus until all preceding reserved jobs in the queue are completed and the outputting of the printed matter which the user reserved is finished.

In printing by making use of a confidential printing function, when a print instruction containing a password is input and the user is identified, the corresponding job is registered at the end of the queue. If, therefore, other jobs have already been registered in the queue at this point of time, the user must stay in front of the image printing apparatus until all the reserved jobs registered in advance in the queue are completed and the outputting of the printed matter which the user requested is finished.

In addition, even in confidential printing, various kinds of information concerning a job, e.g., the name of a file to be printed, the user name, and the type of job, are displayed in list form on the display section of an operation panel. It is therefore impossible to satisfactorily ensure the confidentiality of prints associated with confidential printing.

Furthermore, if the priority of a given job registered in a queue and associated with confidential printing is increased in the output order to print it in preference to other reserved jobs, other users who reserved the preceding jobs registered in the queue are forced to wait, resulting in inconvenience. Furthermore, during this wait time, the information concerning the confidential print job is displayed in list form and exposed to others.

This application is based upon and claims priority under 35 U.S.C. 119 from the Japanese Patent Application Nos. 2004-196313 and 2004-196314 filed in Jul. 2, 2004, at least content of which are incorporated herein by reference.

### SUMMARY OF THE INVENTION

The present invention has been made to solve the above problems, and has as its first object to provide an image printing apparatus and job processing method which can ensure the confidentiality of a document to be output while maintaining a reservation order.

It is the second object of the present invention to provide a display device for an image printing apparatus which can display information concerning a job in the standby state while preventing the leakage of information concerning a job with high confidentiality.

In order to achieve the first object, according to the first aspect of the present invention, there is provided an image printing apparatus comprising an identification section which identifies whether or not a user who manages a job is present in a predetermined range from the image printing apparatus, a queue which manages an execution order of the job, a job registration section which registers the job at the end of the queue and storing the job, and a job management section which suspends the start of execution of the job registered in the queue when the identification section does not recognize the presence of the user who manages the job, and permits the start of execution of the job registered in the queue when the identification section recognizes the presence of the user who manages the job.

In the first aspect, it is identified whether or not the user who manages a job is present in a predetermined range from the image printing apparatus, and the start of execution of the job is suspended if the user is not present. For example, when the user who manages a job is not present in a predetermined distance range even if the job in the queue takes a turn to be executed, the start of execution of the job is suspended.

Identification whether or not the user who manages the job is present in a predetermined range from the image printing apparatus may be performed by a method of collating a physical feature (e.g., a fingerprint, voiceprint, or the blood vessel pattern of a retina) with a camera image in addition to a method using an IC tag. In this case, identification may be performed in the following manner. Each user registers in advance information concerning his/her fingerprint, voiceprint, or blood vessel pattern of the retina such that the registered information can be used by the image printing apparatus. Information concerning the fingerprint, voiceprint, or blood vessel pattern of the retina of a user present near the image printing apparatus is detected by using a physical feature detector provided for the image printing apparatus. Thereafter, the detected information is compared with the registered information, thereby determining whether the user who has submitted the job is identical to the user present near the image printing apparatus. Alternatively, radio waves from a cellular phone which approaches a predetermined range are received to determine, on the basis of the phone number, whether the user in the range is identical to the user who manages the job.

According to the second aspect of the present invention, there is provided an image printing apparatus wherein the identification section in the first aspect comprises a communication section which communicates with only a non-contact communication element present in a predetermined communication range from the image printing apparatus, and the communication section performs identification on the basis of identification information acquired from the non-contact communication element.

According to the second aspect, identification is performed by using the information received from, for example, a non-contact communication element such as an IC tag provided in a medium which can move together with a user who is present in a predetermined communication range from the image printing apparatus. If the image printing apparatus is designed to always try to communicate with a non-contact communication element, identification can be quickly and automatically performed when a non-contact communication element comes within the predetermined communication range from the image printing apparatus. A non-contact communication element is embedded in a terminal device, card, or mascot doll (figure) which is carried by a user.

According to the third embodiment, there is provided an image printing apparatus which includes a job registration section which sequentially stores image information in the order of first image information, second image information, and third image information as jobs submitted by the user, and an image printing section which performs image printing associated with the image information in the order in which the image information is stored in the job registration section, comprising a communication section which communicates with a non-contact communication element including the first identification information concerning the user, an acquisition section which acquires the first identification information from only a non-contact communication element located in a communication range of the communication section, a determination section which determines whether or not a user indicated by the first identification information is identical to a user indicated by the second identification information, after image printing corresponding to the first image information is completed by the image printing section, on the basis of the first identification information acquired by the acquisition section and second identification information concerning the user of the image information stored in association with the second image information, and a control section which suspends the start of image printing operation corresponding to the second image information by the image printing section when the determination section determines that the user indicated by the first identification information is not identical to the user indicated by the second identification information, and permits the start of image printing operation corresponding to the third image information by the image printing section when the determination section determines, on the basis of the third image information which does not include the second identification information or the first identification information acquired by the acquisition section and the second identification information, that the user indicated by the first identification information is identical to the user indicated by the second identification information.

According to the fourth aspect, there is provided an image printing apparatus further comprising a job information display control section which displays information associated with each job registered and stored in the job registration section in the third aspect in list form in registration order.

In the fourth aspect, information indicating the status of each job, e.g., “outputting”, “standing by”, or “waiting for identification”, registered and stored in the job registration section and other information are displayed in list form in the order of registration in the queue.

According to the fifth aspect of the present invention, there is provided an image printing apparatus further comprising a job information display control section which displays information associated with each job registered and stored in the job registration section in the third aspect in list form in registration order, a display limiting section which limits display of information concerning a job, of jobs stored in the job registration section, to which a confidentiality request is attached, by the job information display section, and a limitation cancellation section which cancels, when a job to which limitation of display is imposed by the display limiting section is identified with identification information acquired by the acquisition section, the limitation of display imposed on the job.

According to the fifth aspect, display of information associated with a job to which a confidentiality request is attached is basically limited, and the limitation of display imposed on the job is canceled when the job is identified with identification information. Display of information associated with a job on which no confidentiality request is attached is not limited. A job to which a confidentiality request is attached includes, for example, confidential printing and confidential copying. A confidentiality request may be a request for confidentiality associated with display of job information, and may be independent of a confidentiality request with respect to printed matter, i.e., a request for user identification with respect to a printout.

In order to achieve the second object, according to the sixth aspect of the present invention, there is provided a display device for an image printing apparatus which includes a job registration section which registers and stores image information as a job to be submitted by a user, and an image printing section which performs image printing concerning image information in an order in which the image information is stored in the job registration section, comprising a communication section which communicates with a non-contact communication element including the first identification information concerning the user, an acquisition section which acquires the first identification information from only a non-contact communication element located in a communication range of the communication section, a determination section which determines, on the basis of the first identification information acquired by the acquisition section and second identification information concerning a user of the image information stored in association with the image information, whether or not the user indicated by the first identification information is identical to the user indicated by the second identification information, and a job information display control section which displays information concerning each job registered and stored in the job registration section in list form in an order in which the information is registered in the job registration section.

According to the seventh aspect of the present invention, there is provided a display device further comprising a display limiting section which limits display of information concerning image information stored in the job registration section, when the determination section determines that the user indicated by the first identification information is not identical to the user indicated by the second identification information, and a limitation cancellation section which cancels, when a job on which limitation of display is imposed by the display limiting section is identified with the identification information acquired by the acquisition section, the limitation of display imposed on the job.

In order to achieve the first object, according to the eighth aspect of the present invention, there is provided a job processing method in an image printing apparatus which includes a job registration section which registers and stores image information as a job submitted by the user, and an image printing section which performs image printing concerning the image information in the order in which the image information is stored in the job registration section, comprising the steps of acquiring first identification information concerning the user from only a non-contact communication element through a communication section, storing the acquired first identification information, sequentially reading images concerning the image information through the image printing section, storing the first identification information received from the non-contact communication element in association with the read image data at least at one of the time of start of image reading and the time of end of image reading, and registering a job concerning current image printing operation at the end of the job registration section after completion of image reading.

The image printing apparatus according to the present invention can ensure the confidentiality of a document to be printed while maintaining the order of registration in a queue. When the state of waiting for identification is to be started for a print job which requires identification at the time of output from the point of time when execution of the job should be started, in particular, it is guaranteed that the user who manages the job is present in front of the image printing apparatus at time of the start of printing.

When identification performed before a print job requiring identification at the time of output takes a turn to be executed in the queue is also regarded effective, the user who comes earlier than the execution time can perform identification in advance. With this operation, the user is identified without any delay when the requested job takes a turn to be executed, and hence need not stand by in front of the image printing apparatus.

Assume that even a print job requiring identification at the time of output is to be registered at the end of the queue when the job is submitted. In this case, since the job is registered in the queue as soon as it is submitted, the reservation order can be ensured early.

Assume that the suspension of the execution of a job is canceled when a given user is recognized as the user of the job, and the job is set in the state of waiting for execution in registration order. In this case, the order of jobs registered in the queue is observed, except for jobs that have already been executed, thereby maintaining fairness.

Assume that when the suspension of execution of a given print job is canceled, another print job lower in priority than the given print job is being executed. In this case, when the print job whose suspended state has been canceled is to be executed upon interrupting the execution of anther print job, printed matter can be obtained without waiting for the end of the currently executed job.

When the interruption timing is to be adjusted in accordance with the attributes of another job under execution, interruption can be performed without affecting printed matter to be generated by avoiding interruption at an inconvenient timing for postprocessing or image printing.

When the statuses of the respective jobs registered in a queue are to be displayed in list form in the order of registration in the queue, statues such as “outputting”, “standing by”, and “waiting for identification” are displayed in list form in the order of registration in the queue in correspondence with the respective jobs registered in the queue. With this operation, even when an interruption occurs during the execution of a print job requested by a given user, the user can understand the reason of the interruption, and agrees to wait for the end of the interruption.

Assume that identification is performed on the basis of the identification information acquired from an identification information provider only when the presence of the identification information provider within a predetermined range from the image printing apparatus is recognized, or identification is performed by using the information received from a non-contact communication element present in a predetermined communication range from the image printing apparatus. In this case, when the corresponding user is not present near the image printing apparatus, no printed matter is output. This can therefore maintain the confidentiality of the printed matter.

Assume that when no identification information associated with a job requiring identification has been acquired, display of job information of the job is limited. In this case, even when information associated with a job in the state of waiting for execution is displayed on an operation panel, the leakage of information associated with a job with high confidentiality can be prevented. That is, while a user carrying a non-contact communication element or the like which transmits identification information is present in front of the image printing apparatus, information associated with a job identified by the identification information is displayed. While the user is not present in front of the image printing apparatus, display of information associated with the job is limited. This can therefore prevent the confidentiality of the job from being impaired by the display section in the absence of the user.

Displaying information that can identify the existence of a job on which limitation of display is imposed makes it possible to inform a user of the existence of the job in the state of waiting for execution while maintaining confidentiality.

Limiting display of information, of information associated with a job, which indicates the contents of the job or allows estimation of the contents of the job will conceal important information for the maintenance of confidentiality.

Displaying information representing an amount associated with the processing time of a job on which limitation of display is imposed makes it possible to give an indication of a wait time to the use who is waiting for the execution of the job while maintaining confidentiality.

Assume that when a job is submitted in a state wherein identification information has been acquired, the job is registered with a confidentiality request identified with the identification information being attached to the job. In this case, the user need not perform confidentiality setting by himself/herself, thus improving convenience.

Assume that when an authenticated user moves away from the image printing apparatus before the start of execution of a job, the start of execution of the job is suspended again, and the job is set in the state of waiting for identification. In this case, when a user who came in front of the apparatus moves away from the apparatus, there is no chance that confidential printed matter is output in the absence of the user.

Assume that it is identified whether or not a user who manages the job is present within a predetermined range from the image printing apparatus, and the start of execution of the job is suspended when the user is not present, or the start of execution of the job is permitted under the condition that the presence of the user who manages the job is recognized. In this case, a document with high confidentiality can be prevented from being seen by others.

Since display of information associated with a job for which a confidentiality request is issued is limited until the user of the job is qualified, the leakage of information associated with a job with high confidentiality can be prevented even when information associated with a job in the state of waiting for execution is displayed on the operation panel.

When information which allows identification of the existence of a job on which limitation of display is imposed is displayed, the existence of a job in the standby state can be informed to the user while confidentiality is maintained.

When display of information, of the information associated with a job, which represents the contents of the job or allows estimation of the contents of the job is limited, important information is concealed to maintain confidentiality.

Displaying information associated with the time required for a job on which limitation of display is imposed is displayed makes it possible to give an indication of a wait time to a user who is waiting for execution of the job while maintaining confidentiality.

If the apparatus is configured to permit display or cancel limitation of display when a user is qualified, display of information associated with a job to which permission of display is given once can be limited again. This allows the user who manages the job to move away from the image printing apparatus while information associated with the job is concealed if there is a wait time until the start of execution of the job.

Assume that identification information is to be acquired from only an identification information provider present in a predetermined range from the image printing apparatus or identification information is to be acquired from only a non-contact communication element present in a predetermined communication range from the image printing apparatus. In this case, when the corresponding user is not present near the image printing apparatus, information associated with the job is not displayed, and hence leakage of the information to the other can be prevented.

Assume that when the identification information used for the identification of a job ceases to be received, the user is disqualified with respect to the job, and the permission of display or cancellation of limitation with respect to the job is canceled. In this case, when no identification information is acquired, display of information associated with the job for which the user has been qualified by the identification information is limited again. When, for example, the user leaves the image printing apparatus and identification information ceases to be received, display of information associated with the job requested by the user is limited again to maintain confidentiality.

Assume that when a job is submitted while identification information has been acquired, the job which is identified with the identification information and to which a confidentiality request is attached is registered. In this case, the user need not perform any operation to add a confidentiality request by himself/herself, resulting in an improvement in convenience.

The above and many other objects, features and advantages of the present invention will become manifest to those skilled in the art upon making reference to the following detailed description and accompanying drawings in which preferred embodiments incorporating to the principle of the present invention are shown by way of illustrative examples.

### BRIEF DESCRIPTION OF THE DRAWINGS

FIG. 1 is a view for explaining a usage pattern of an image printing apparatus according to embodiments of the present invention;

FIGS. 2A and 2B are block diagrams respectively showing image printing apparatuses according to the first and second embodiments of the present invention;

FIG. 3 is a view schematically showing an example of how the execution order of jobs is managed by using a queue;

FIG. 4 is a view schematically showing another example of how the execution order of jobs is managed by using a queue;

FIG. 5 is a flowchart showing operation to be performed when a confidential copy job is submitted;

FIG. 6 is a flowchart showing the processing performed by a job management section;

FIG. 7 is a view for explaining an example of a reservation list window displaying the contents of a queue in list form;

FIG. 8 is a view for explaining an example of a reservation list window in a state wherein the job of No. 002 in the state shown in FIG. 7 is recognized as a job of a user who manages it;

FIG. 9 is a view for explaining an example of a reservation list window in a state wherein the job of No. 003 in the state shown in FIG. 8 can be interrupted;

FIG. 10 is a view for explaining an example of a reservation list window in a state wherein the job of No. 003 in the state shown in FIG. 8 is ended;

FIG. 11 is a view for explaining an example of a reservation list window in a state wherein the job of No. 004 in the state shown in FIG. 10 is recognized as a job of a user who manages it;

FIG. 12 is a view for explaining an example of a reservation list window in a state wherein the job of No. 002 in the state shown in FIG. 11 is recognized as a job of a user who manages it;

FIG. 13 is a view for explaining an example of a reservation list window displaying the contents of a queue in list form;

FIG. 14 is a flowchart showing processing associated with display of a reservation list window;

FIG. 15 is a view for explaining an example of a reservation list window including jobs, display of which is completely limited;

FIG. 16 is a flowchart showing processing associated with display of a reservation list window in which display of part of job information is limited;

FIG. 17 is a view for explaining an example of a reservation list window in which information in “name” is concealed owing to limitation of display;

FIG. 18 is a view for explaining an example of a reservation list window in which information in “sheet count” corresponding to jobs on which limitation of display is imposed is displayed;

FIG. 19 is a view for explaining an example of a reservation list window in which display of job information associated with a job currently subjected to output processing is limited;

FIG. 20 is a view for explaining an example of a reservation list window displaying “time required” with respect to jobs on which limitation of display is imposed; and

FIG. 21 is a view for explaining an example of a reservation list window displaying “estimated end time” with respect to a job on which limitation of display is imposed.

### DETAILED DESCRIPTION OF THE PREFERRED EMBODIMENTS

Some preferred embodiments of the present invention will be described below with reference to the accompanying drawings.

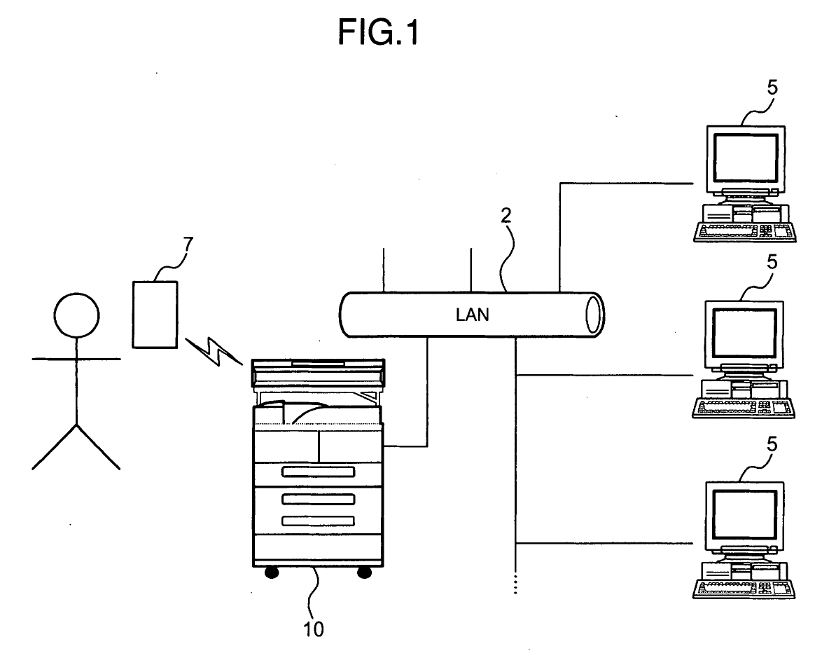

FIG. 1 shows a usage pattern of an image printing apparatus 10 according to an embodiment of the present invention. The image printing apparatus 10 is connected to a LAN (Local Area Network) 2, and is connected to a print data transmission device 5 such as a personal computer through the LAN 2. The image printing apparatus 10 is configured as a so-called multifunction apparatus, which has, for example, a printing function of printing an image on a printing sheet in accordance with the print data sent from the print data transmission device 5 or the like and outputting the sheet and a copying function of reading an original image, printing a copy on a printing sheet, and outputting it. This apparatus further has a function of binding printed out printing sheets with staples.

The image printing apparatus 10 also has a confidential printing function of printing documents with high confidentiality and a confidential copying function of copying originals with high confidentiality. The confidential printing or confidential copying function is a printing function in which when a user submits a job, user information is registered in association with the job, and user identification is required when printout operation is performed. A confidentiality request is attached to the job.

Identification of the user associated with confidential printing or confidential copying is done by using an ID card 7 in which an IC tag is embedded. The IC tag embedded in the ID card 7 records identification information (user information) by which the user can be uniquely specified. When the user carrying the ID card 7 comes within a predetermined distance range from the image printing apparatus 10, the image printing apparatus 10 can read the information in the ID card 7.

Note that the IC tag may be mounted in anything that the user carries, e.g., a mascot doll (figure) or portable terminal instead of the ID card 7. In this case, the IC tag may be incorporated or embedded in such a doll or portable terminal. In addition, a transmitter for user information is not limited to the IC tag, and another kind of non-contact communication element may be used as long as it can transmit user information to the image printing apparatus 10 by non-contact communication.

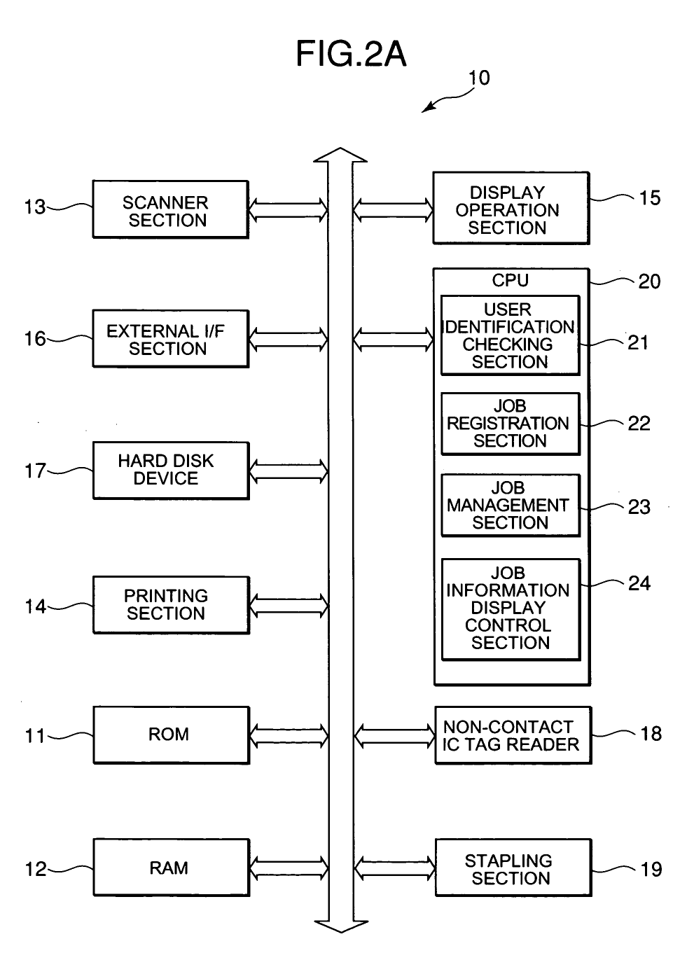

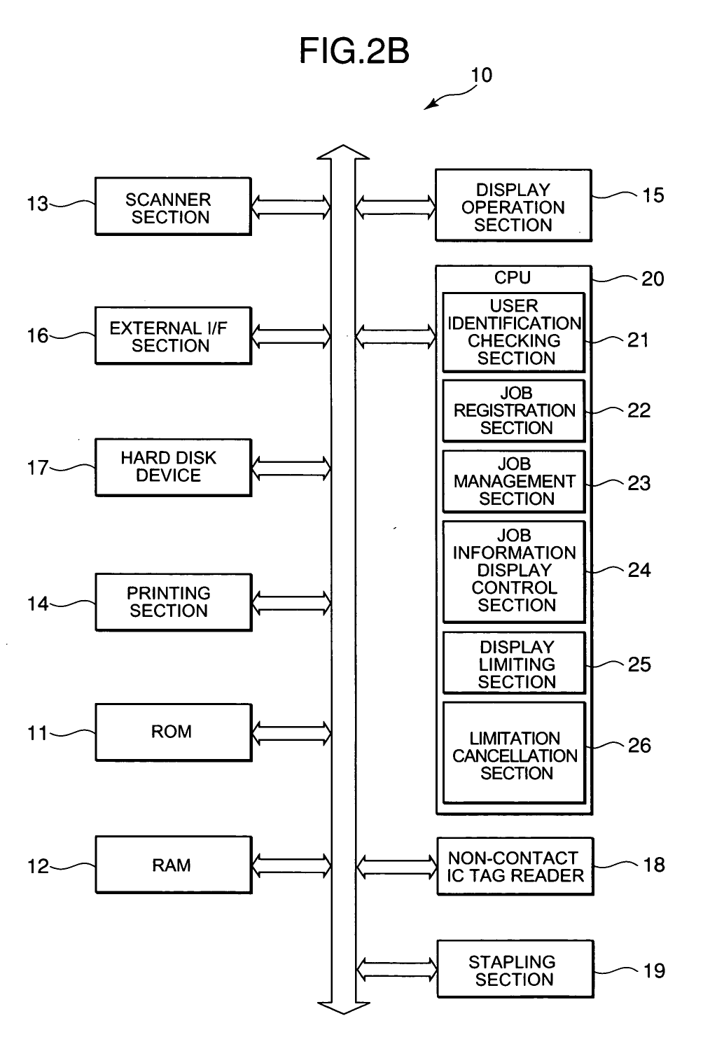

FIGS. 2A and 2B respectively show the arrangements of the image printing apparatuses 10 according to the first and second embodiments of the present invention.

In either embodiment, the image printing apparatus 10 is comprised of a circuit including, as main components, a CPU (Central Processing Unit) 20 which performs overall control on the operation of the apparatus, a ROM (Read-Only Memory) 11, and a RAM (Random Access Memory) 12. The ROM 11 stores the programs to be executed by the CPU 20 and various kinds of fixed data. The RAM 12 functions as a work memory which temporarily stores various kinds of data when the CPU 20 executes a program and a page memory which stores image data to allow various kinds of processing and editing to be performed for the image to be printed.

### First Embodiment

A scanner section 13 functions to read an original image and capture the corresponding image data. The scanner section 13 includes a light source which irradiates an original with light, a line image sensor which reads a one-line portion of the original in its width direction, a moving section which moves the read position line by line in the length direction of the original, and an optical path which is comprised of lenses and mirrors and guides reflected light from the original to the line image sensor to form it into an image thereon. The line image sensor is formed from a CCD (charge Coupled Device). The analog image signal output from the line image sensor is A/D-converted to be captured as digital image data.

A printing section 14 functions to print an image corresponding to image data on a printing sheet by an electrophotographic process and output it. The printing section 14 is configured as a so-called laser printer including a printing sheet convey device, photosensitive drum, charging device, laser unit, developing device, transfer/separation device, cleaning device, and fixing device.

A display operation section 15 is comprised of a liquid crystal display having a touch panel on its surface and various kinds of operation switches, and has a function of displaying various kinds of information and statuses to a user and accepting various kinds of operations from the user.

An external I/F section 16 functions to communicate with an external device such as a print data transmission device 5 through the LAN 2.

A hard disk device 17 is a large-capacity storage device which is used to store the print data received from the print data transmission device 5 and the like and the image data obtained by bitmapping the print data in addiction to the image data obtained by reading by the scanner section 13. This device also stores various kinds of information concerning a requested job.

A non-contact IC tag reader 18 serving as an identification information acquisition section functions to read information by communicating with the IC tag embedded in an ID card 7. In this case, in order to recognize the user in front of the image printing apparatus 10, a diameter range of about one meter from the non-contact IC tag reader 18 is set as a communicative range in which the information of the IC tag can be read. This range may be set to an appropriate size. In addition, the size or directivity of the communicative range may be changed as needed. Note that the non-contact IC tag reader 18 may communicate with the ID card 7 periodically (e.g., once per 200 msec) to check whether or not the user holding the ID card 7 is continuously present within the communicative range (near the image printing apparatus 10).

A stapling section-19 functions to bind the recording sheets printed out by the printing section 14 with staples.

A CPU 20 functions as a user identification checking section 21 serving as an identification section and identification cancellation section, a job registration section 22, a job management section 23, and a job information display control section 24. Note that in the image printing apparatus according to the second embodiment shown in FIG. 2B, the CPU 20 also functions as a display limiting section 25, and limitation cancellation section 26.

The identification checking section 21 identifies the user (identifies whether or not the current job is a job managed by the user) on the basis of the user information (first identification information) read from the ID card 7 through the non-contact IC tag reader 18. The identification checking section 21 also functions to cancel the necessity of user identification with respect to the job when the non-contact IC tag reader 18 ceases to acquire the user information used for user identification. That is, each job is subjected to user identification only during a period in which the non-contact IC tag reader 18 receives the corresponding user information.

The job registration section 22 functions to register a submitted print job at the end of a queue and store it.

The job management section 23 functions to manage the execution order of jobs registered in the queue.

The job information display control section 24 functions to create screen data for displaying information concerning the jobs registered in the queue in list form on the display operation section 15.

The display limiting section 25 in the second embodiment functions to display, on the display operation section 15 through the job information display control section 24, job information concerning a job, of the jobs registered in the queue, to which a confidentiality request for confidential printing or confidential copying is attached and limit display contents. The limitation cancellation section 26 functions to cancel the limitation of display on the job on which limitation of display has been imposed when the user is identified on the basis of the user information (first identification information) acquired from the non-contact IC tag reader 18.

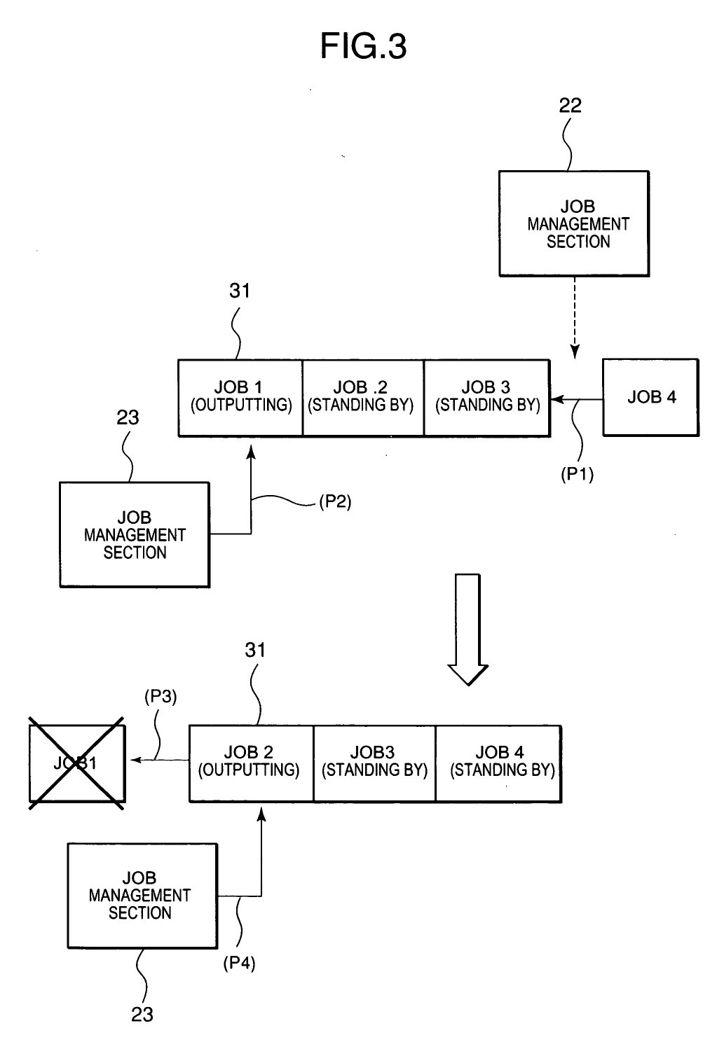

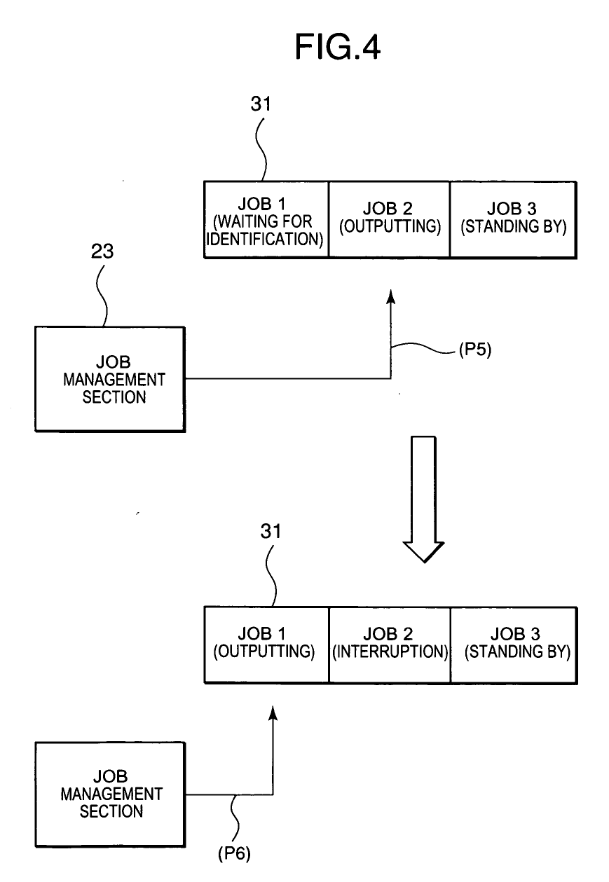

FIGS. 3 and 4 schematically show how the job management section 23 manages the execution order of jobs by using a queue. A queue 31 is a queue in which print jobs are arranged in registration order. As shown in FIG. 3, the job registration section 22 adds a print job to the end of the queue 31 (P1) when it is submitted, regardless of whether the job is a job requiring identification at the time of output in confidential printing or confidential copying, i.e., the print job and identification information (second identification information) of the user who has submitted the print job are registered in association with each other. The status of the job registered in the queue 31 includes “standing by”, “outputting”, “waiting for identification”, and “stopping”.

“Standing by” indicates a state wherein the job is waiting for output operation in a ready state. “Outputting” indicates a state wherein printing is currently performed. “Waiting for identification” indicates a state wherein a print job associated with confidential printing or confidential copying is waiting for user identification. “Stopping” indicates a state wherein printing out is stopped halfway by the interruption of another job with a priority higher than that of the self-job, and is waiting for resumption. The job registration section 22 registers the job with the status “standing by” at the end of the queue 31. The job management section 23 functions to change the status of each job in accordance with the necessity of user identification or the execution state of each job.

The job management section 23 sequentially executes jobs from the job at the head of the queue 31 (P2), removes each job from the queue 31 after it is executed (P3), and increases the priorities of the subsequent jobs one by one. The job located at the head of the queue after the priorities are increased is to be executed next (P4).

If a job for confidential printing or confidential copying is at the head of the jobs managed by the queue 31, it is determined, on the basis of the user information (first identification information) acquired by the non-contact IC tag reader 18 and the second identification information associated with the job, whether the user holding the ID card 7 is identical to the job who has submitted the job. If it is determined that the user holding the ID card 7 is identical to the user who has submitted the job, image printing operation is started. If it is determined on the basis of the first identification information and second identification information that the user holding the ID card 7 is not identical to the user who has submitted the job, the job is set in the status “waiting for identification”, as shown in FIG. 4, and the start of execution is suspended. It is then checked whether or not the job at the second highest priority in the queue can be executed. If this job can be executed, the execution of the job is started, and its status is set to “outputting” (P5).

From the viewpoint of the confidentiality of printed matter, the printed sheet corresponding to the job is preferably delivered while the user who has submitted the job is preset near the image printing apparatus. If the timing of user identification based on the first identification information and second identification information for the start of image printing operation is too early, the user may be away from the image printing apparatus after identification. For this reason, user identification associated with the start of image printing operation based on the first identification information and second identification information is preferably performed at least after the completion of image printing operation based on the immediately preceding job. More preferably, user identification based on the first identification information and second identification information is performed at either the timing at which image printing operation corresponding to the immediately preceding job is completed or at the timing at which the corresponding job is set at the head of the queue. Obviously, in addition to this operation, whether or not the user holding the ID card 7 is identical to the user who has submitted the job may be determined on the basis of the first identification information and second identification information.

In this case, whether the user holding the ID card 7 is identical to the user who has submitted the job may be determined by determining whether or not the first identification information is identical to the second identification information, or may be determined by using third information associated with the first identification information and/or the second identification information.

When the non-contact IC tag reader 18 acquires new user information, and user identification is completed for the job suspended due to “waiting for identification” by using this information, the status of the job is returned from “waiting for identification” to “standing by”. If this job is the job at the highest priority in the queue, i.e., the job with the status “standing by” which was registered in the queue at the earliest timing, the job is executed preferentially. That is, if another job lower in priority than this job, i.e., another job registered after this job, is in the status “outputting” when the status is returned to “standing by”, this job is executed upon interrupting the execution of this job (P6). As a result, the status of this job changes to “outputting”, and the status of the interrupted job changes to “stopping”.

In the above embodiment, when a print job is registered in the queue, “standing by” is displayed on the display operation section 15, and the display of “standing by” is changed to “waiting for identification” if it is determined on the basis of the first identification information and second identification information that the user holding the ID card 7 is not identical to the user who has submitted the job. However, the present invention is not limited to this. If the print job is registered in association with the second identification information, when the job is registered in the queue, “waiting for identification” may be displayed, and “standing by” may be displayed upon completion of identification.

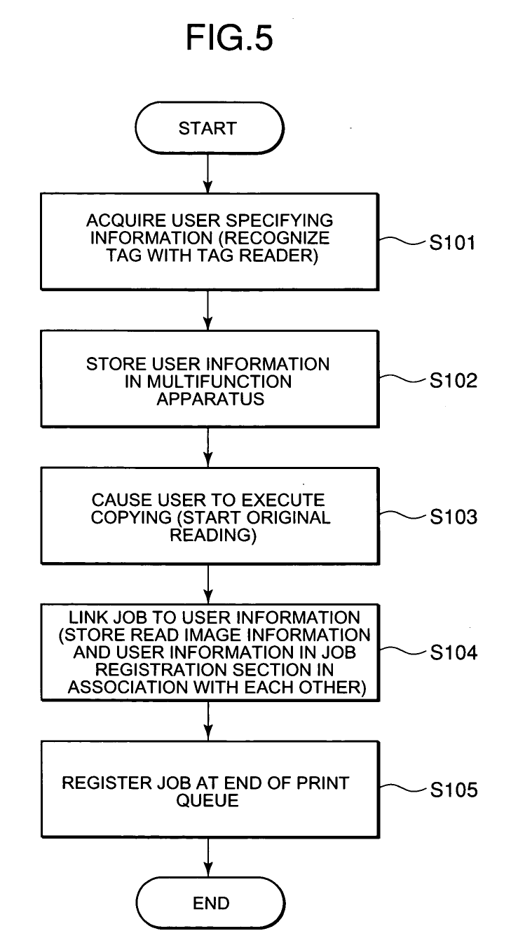

FIG. 5 is a flowchart showing operation to be performed when a job for confidential copying is submitted. When the user carrying the ID card 7 approaches the communicative range of the image printing apparatus 10, the non-contact IC tag reader 18 acquires user information from the ID card 7 (step S101). The image printing apparatus 10 stores this user information (step S102). When the user operates the copy start button (not shown) after placing an original, the image printing apparatus 10 reads images on the original through the scanner section 13, and sequentially stores image data in the hard disk device 17 (step S103).

If the non-contact IC tag reader 18 has received user information from the ID card 7 at least at the start of reading the original or at the completion of reading the original, the user information and read image data are stored in association with each other (step S104). By associating the user information with the image data, the current copying operation is handled as confidential copying. When the reading of the original is complete, the job associated with the current confidential copying operation is registered at the end of the queue 31 (step S105).

If the non-contact IC tag reader 18 has not received user information from the ID card 7 at least at the start of reading the original or at the completion of reading the original, the job associated with the current copying operation is registered as a general job at the end of the queue 31. Even if user information has been received, the corresponding job can be registered as a general copy job depending on the operation performed by the user or environment setting. Alternatively, the apparatus may be configured to allow the user to designate confidential copying through the display operation section 15.

Assume that a print request is received from the print data transmission device 5. In this case, if user information is contained in the header of the like of the received print data, the corresponding job is registered, at the end of the queue 31, as a print job associated with confidential printing to which a confidentiality request is attached.

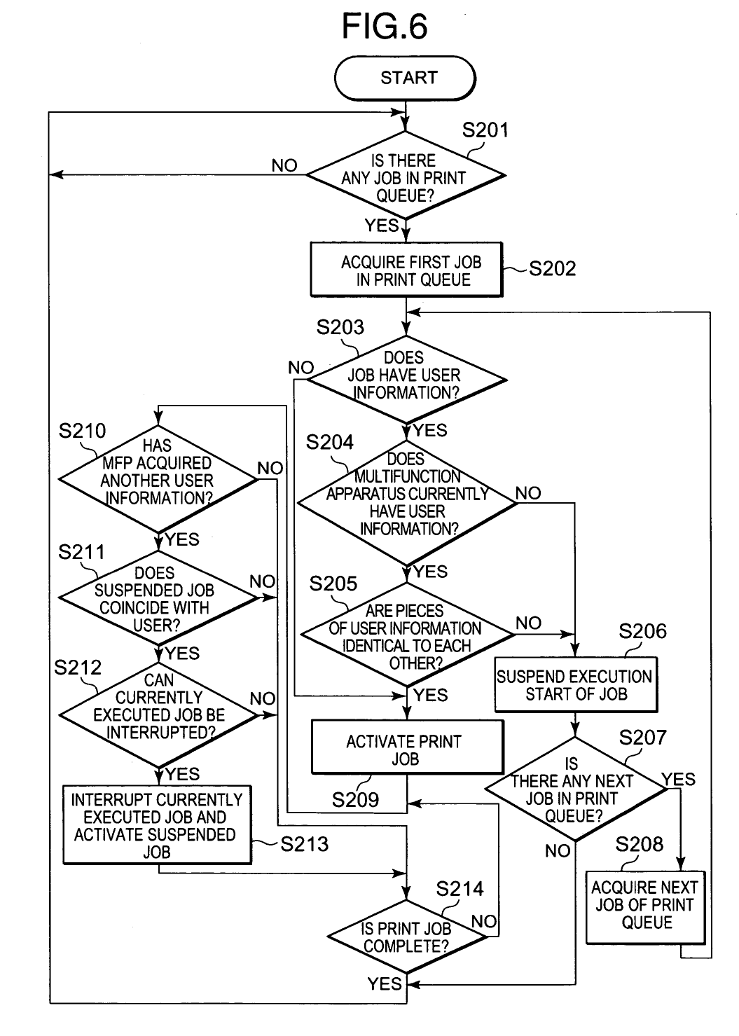

FIG. 6 is a flowchart showing the processing performed by the job management section 23. The job management section 23 checks whether the queue 31 contains a print job with the status “standing by” (step S201). If the queue contains such jobs (YES in step S201), the job management section 23 acquires one of the jobs with the status “standing by” which is nearest to the head of the queue 31 (step S202). The job management section 23 checks whether this job requires user identification at the time of output (step S203). If the job requires user identification (YES in step S203), the job management section 23 checks whether the non-contact IC tag reader 18 has acquired user information from the IC tag in the ID card 7 at the current point of time (step S204). Note that a state wherein the non-contact IC tag reader 18 has received user information from the IC tag in the ID card 7 is expressed as a state wherein the image printing apparatus 10 has user information.

If the image printing apparatus 10 has no user information (NO in step S204) or the user information held by the image printing apparatus 10 differs from user information required for user identification for this job (NO in step S205), the start of execution of the job is suspended in the state of waiting for user identification (step S206).

In this case, if user information identical to the user information registered in association with the job has been acquired from the IC tag in the ID card 7, user identification is completed. In addition, the user information currently received from the IC tag in the ID card 7 by the non-contact IC tag reader 18 is compared with the user information registered in association with the job.

The job management section 23 checks whether or not any next job with the status “standing by” exists in the queue 31 (step S207). If such a job exists in the queue (YES in step S207), the job management section 23 acquires the job (step S208). The flow then returns to step S203. If there is no job with the status “standing by” in the queue 31 (NO in step S207), the flow returns to step S201.

If the job acquired from the queue 31 requires no user identification (NO in step S203) or the job requires user identification but user identification has already been done (YES in step S205), the execution of the job is started (step S209).

During the execution of printing, the following processing (steps S210 to S213) is repeatedly performed (NO in step S214). The repeating period is about 200 msec. First of all, the job management section 23 checks whether the non-contact IC tag reader 18 has acquired another user information from the ID card 7 (step S210). If the non-contact IC tag reader 18 has acquired another user information (YES in step S210), the job management section 23 checks whether or not the acquired user information requires user identification with respect to the suspended job (step S211).

If user identification is required with respect to the suspended job (YES in step S211), the job management section 23 checks on the basis of the attributes or status of the currently executed job whether or not the job can be interrupted (step S212). For example, the currently executed job cannot be interrupted in a case wherein the job requires binding of a plurality of printing sheets with staples and all the pages corresponding to the unit of binding are not completely printed, or in a case wherein printing of the lower surface of a printing sheet is not completed in double-sided printing. On the other hand, the current executed job can be interrupted, for example, at the timing when one unit (copy) of pages are completely printed, at the timing when printing of one surface of a printing sheet is completed in the single-sided printing mode, at the timing when printing of the upper and lower surfaces of a printing sheet is completed in the double-sided printing mode, and at the timing when printing of each predetermined number of copies of printing sheets is completed. Note that if the currently executed job cannot be interrupted, image printing operation for the suspended job may be started after image printing operation for the currently executed job is complete.

If the currently executed job can be interrupted (YES in step S212), the job is interrupted, and the execution of the job currently released from the suspended state upon completion of user identification is started (step S213).

If no another user information has been acquired from the ID card 7 (NO in step S210) or another user information has been acquired but the user of the suspended job is not identical to the corresponding user (NO in step S211) or the currently executed job cannot be immediately interrupted (NO in step S212), the job management section 23 repeats the above processing (steps S210 to S212) until printing is complete (NO in step S214).

If the execution of the print job is complete (YES in step S214), the flow returns to step S201 to continue the processing.

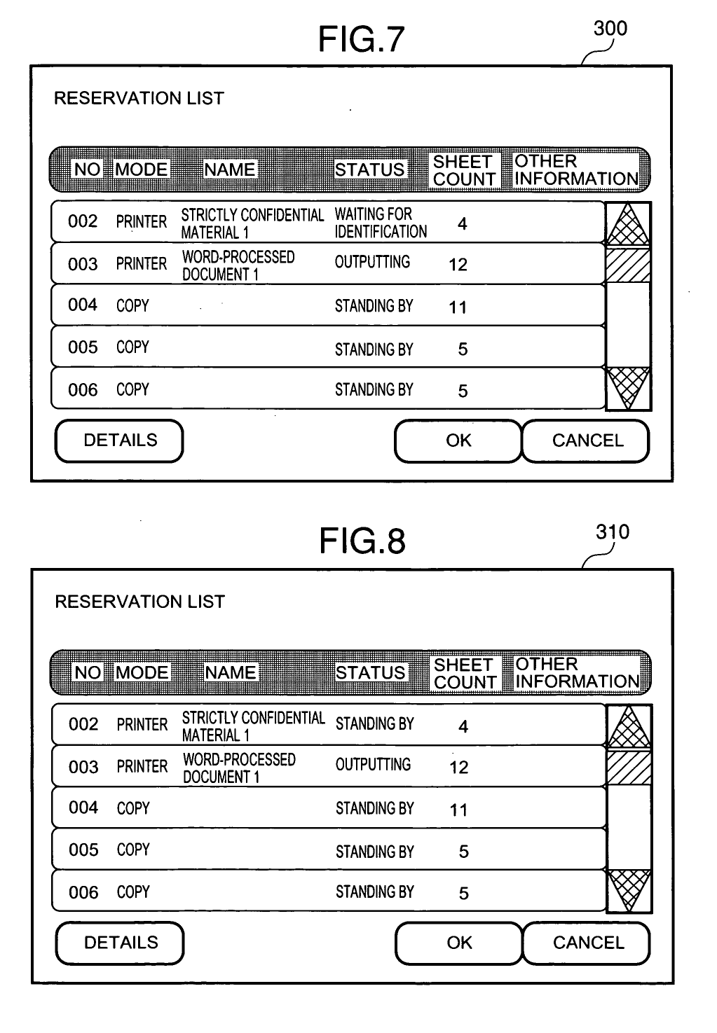

FIG. 7 shows an example of the reservation list window in which the contents of the queue 31 are displayed in list form. In a reservation list window 300, the jobs registered in the queue 31 are sequentially displayed, in list form, starting from the head of the queue 31. This list displays information associated with the priority of each job, the attributes of each job, the status of each job, and information indicating whether or not each job is associated with second identification information, for each job, such as “job number”, “mode”, “name”, “status”, “sheet count”, and “other information”. Note that in addition to the above items, second identification information itself concerning the user who has designated each job may be displayed.

“Job number” indicates the serial number automatically assigned to a submitted job by the image printing apparatus 10. “Mode” indicates whether the corresponding job is associated with the printing function or copying function. “Name” indicates the file name of print data or the job name designated by the user when the corresponding job is associated with the printing function. “Status” indicates the status of the corresponding job in the queue 31. “Sheet count” indicates the number of required sheets subjected to printing associated with the corresponding job. As “other information”, information indicating whether or not the corresponding job requires user identification, information indicating whether or not user information required for user identification for the corresponding job is currently received, or the like is displayed.

The reservation list window 300 shown in FIG. 7 indicates a state wherein the job (No. 002) at the head of the queue 31 is held in the state of waiting for user identification, and the next job (No. 003) is currently executed. The status of the job of No. 002 is displayed as “waiting for identification” to notify the user that the job is waiting for user identification. In addition, it is obvious from this display that since the job of No. 002 is suspended, the job of No. 003 which is second in priority is set in “outputting”.

A reservation list window 310 shown in FIG. 8 indicates a state wherein the job of No. 002 in the state shown in FIG. 7 is recognized as a job of the user who manages it. In this case, the job of No. 003 includes the processing of binding sheets with staples and is in a state wherein its execution cannot be interrupted, and hence the job of No. 002 recognized as a job of the user is set in “standing by”.

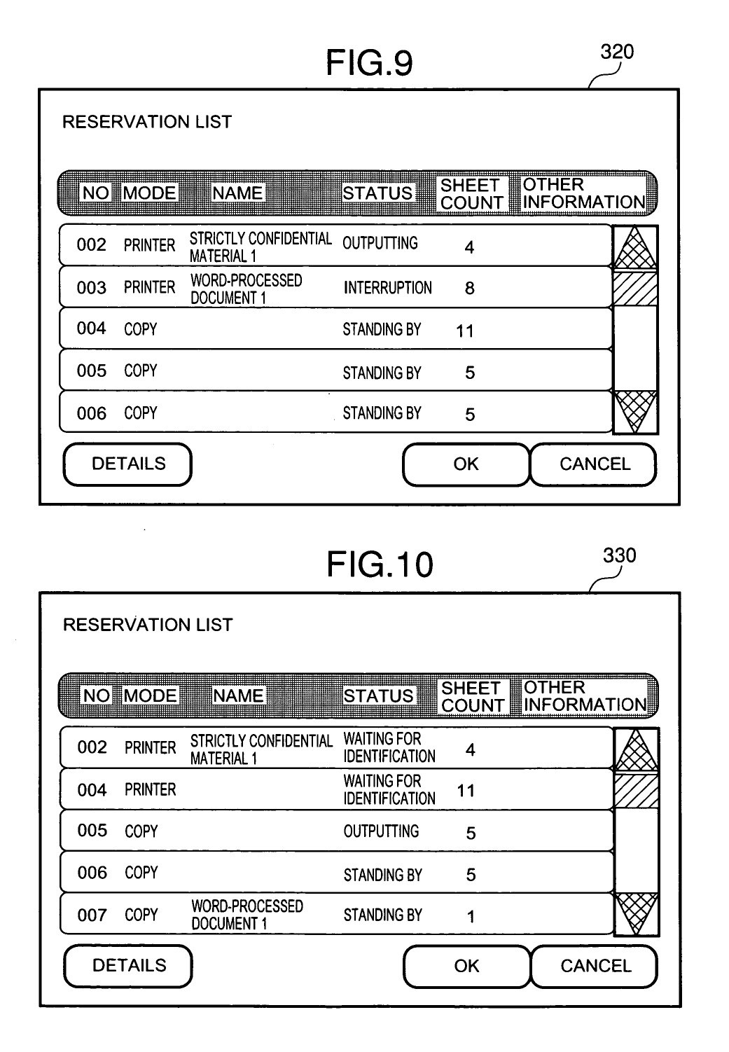

A reservation list window 320 shown in FIG. 9 indicates a state wherein the job of No. 003 in the state shown in. FIG. 8 is interrupted upon being recognized as a job that can be interrupted, and the job of No. 002 is set in “outputting”. The job of No. 003 is interrupted in a state wherein the number of remaining sheets subjected to printing is eight.

FIG. 10 shows a reservation list window 330 after the job of No. 003 in the state shown in FIG. 7 is complete. In this case, the job of No. 004 registered after the job of No. 003 is also set in the state of waiting for user identification, and the job of No. 005 registered at the next priority is set in “outputting”.

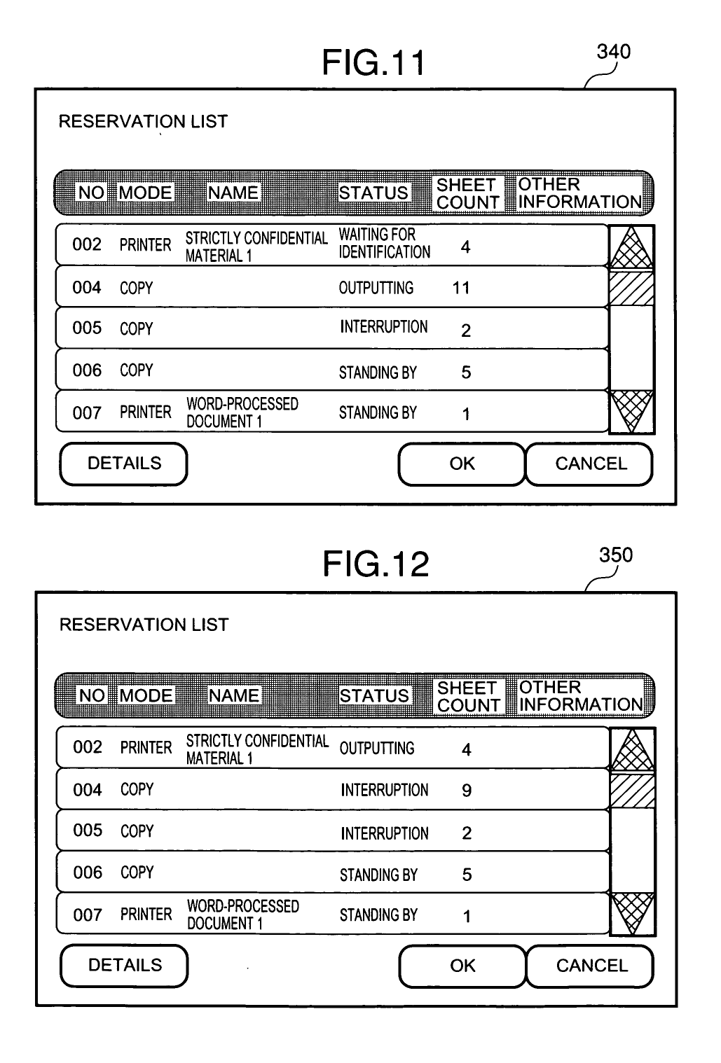

A reservation list window 340 shown in FIG. 11 shows a state wherein the job of No. 004 in the state shown in FIG. 10 is recognized as a job of the user who manages it. As a consequence, the job of No. 004 is released from the suspended state and set in “outputting”. The job of No. 005 is interrupted upon interruption by the job of No. 004 which is higher in priority.

A reservation list window 350 shown in FIG. 12 indicates a state wherein the job of No. 002 in the state shown in FIG. 11 is recognized as a job of the user who manages it. As a consequence, the job of No. 002 is released from the suspended state and set in “outputting”. The job of No. 004 is interrupted upon interruption by the job of No. 002 which is higher in priority. As described above, after a given job is released from the suspended state due to a wait for user identification, the job is processed in accordance with the order of registration in the queue 31.

The above case has exemplified user identification associated with the start of image printing operation and based on the first identification information and second identification information. Control associated with display of a reservation list window on the display operation section 15 will be described along with this case.

If the non-contact IC tag reader 18 has not acquired the first identification information or it is determined that the user indicated by the acquired first identification information is not identical to the user indicated by the second identification information, the display of information associated with image information registered in the queue may be limited. Note that limiting the display of the information indicates non-display of all information or part of the information. Assume that while the non-contact IC tag reader 18 acquires the first identification information, it is determined that the user indicated by the first identification information is identical to the user indicated by the second identification information. In this case, display of information associated with image information registered in the queue may be permitted. The details of such an embodiment will be described later as the second embodiment.

Although the first embodiment of the present invention has been described with reference to the accompanying drawings, the practical arrangement of this apparatus is not limited to the embodiment shown in the drawings, and changes and additions within the spirit and scope of the present invention are incorporated in the invention.

Although user identification is performed by using an IC tag in the first embodiment, user identification may be performed by other methods. For example, input operation for user information may be accepted through the display operation section 15 of the image printing apparatus 10 or user information may be received from a communication terminal such as a cellular phone.

In the first embodiment, when execution of a given job in the queue 31 is to be started, user identification for the job is accepted. However, the apparatus may be configured to accept user identification even in the standby state. When, for example, a user who has requested a print job from the print data transmission device 5 comes in front of the image printing apparatus 10, user identification is accepted at this point of time even if the requested job is in the standby state. With this operation, even if the user temporarily moves away from the image printing apparatus 10, printing is started as soon as the job has a turn to be executed, thereby avoiding unnecessary suspension. In addition, if user identification is performed in advance in the standby state, the user can wait at ease for a turn to output while observing the output state at a distance from the image printing apparatus 10.

In the first embodiment, when a job is submitted, the job is registered at the end of the queue 31 regardless of whether the job is a print job which requires user identification at the time of output. However, the timing of registration of a job for confidential printing or the like in the queue 31 is not limited to the above.

In addition, when a given job is released from the state of waiting for identification and another print job lower in priority than the given print job is being executed, the execution of the lower priority job is interrupted. However, the given job may be executed after the currently executed job is completed.

In the first embodiment, a stapling process is presented as an example in which the execution of a job cannot be interrupted. However, the present invention is not limited to this, and examples in which the execution of a job cannot be interrupted include a case wherein interruption will cause inconvenience in a print result and a case wherein the execution of a job cannot be interrupted in terms of the arrangement of the apparatus. For example, such a case corresponds to the point of time when printing of one surface of each printing sheet is complete in double-sided printing. In addition, when a job that interrupts differs in the type of printing sheet from a job that is interrupted while a plurality of printing sheets are flowing in the apparatus, the execution of the job cannot be interrupted until printing of the currently conveyed printing sheets is completed.

Assume that before a job, which was previously identified by the first and second identification information and the status of it is “Standing by” is executed, user information used to identify the user of this job (the first identification information) ceases to be received. In this case, the job may be set in the state of waiting for user identification to suspend its execution. For example, in the case shown in FIG. 7, the job of No. 002 waits until the job in “outputting” (No. 003) can be interrupted, while the job of No. 002 is recognized as a job of the user. In this state, if the user who manages the job of No. 002 moves away from the image printing apparatus 10, the job is set in the state of waiting for identification again. This prevents a document with high confidentiality from being printed in the absence of the user who manages the job.

In the first embodiment, the presence of the user who manages the job near the image printing apparatus 10 is recognized by user identification using an IC tag. However, the presence of the user who manages the job may be recognized independently of this user identification, and the start of execution of the job may be suspended while the presence of the user who manages the job is not recognized. In addition, the start of execution of the job may be permitted under the condition that the presence of the user who manages the job is recognized.

Furthermore, in performing output operation, when user information associated with a job which requires user identification is received while the job is in the standby state, the word “confidential” is displayed in the “other information” column to notify the user of the reception of the information. However, the notification method is not limited to the above method. For example, this notification may be done by displaying an icon or displaying the background or characters in the corresponding item in a color different from the color of those in other items.

### Second Embodiment

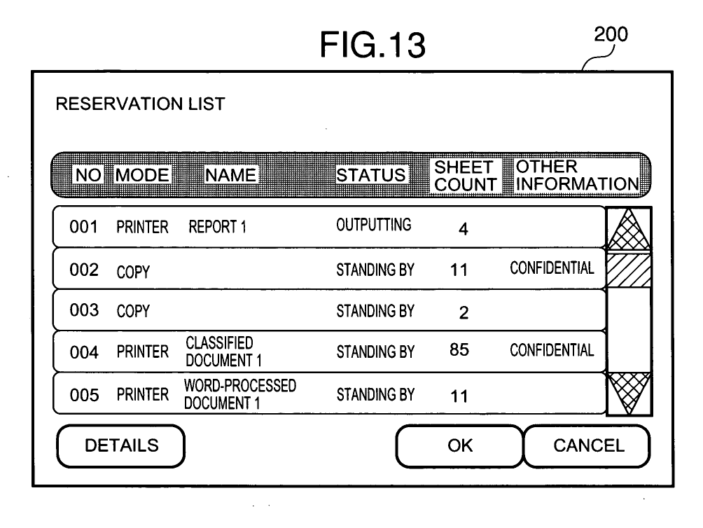

FIG. 13 shows an example of a reservation list window 200 which displays the statuses of the jobs registered in a queue. In the reservation list window 200, information associated with the image information of the jobs registered in a queue 31 is sequentially displayed in list form, starting from the head of the queue 31. With regard to a job to which a confidentiality request is attached, information associated with the job is normally displayed only for a period during which a non-contact IC tag reader 18 receives user information corresponding to the job (only for a period during which user identification is done). In a period during which user information corresponding to the job is not received, the associated information to be displayed is limited.

In the case of normal display, this reservation list (print queue list) displays, for each job, information associated with the priority of each job, the attributes of each job, the status of each job, and information indicating whether or not the job is associated with the second identification information, such as “job number”, “mode”, “name”, “status”, “sheet count”, and “other information”. Note that in addition to the above items, the second identification information itself associated with the user who has designated the job may be displayed. FIG. 13 shows an example of normal display of all jobs.

“Job number” indicates the serial number automatically assigned to a submitted job by an image printing apparatus 10. “Mode” indicates whether the corresponding job is associated with the printing function or copying function. “Name” indicates the file name of print data or image data associated with a print job or the job name designated by the user. “Status” indicates the status of the corresponding job in the queue 31. “Sheet count” indicates the number of required sheets subjected to printing associated with the corresponding job. In the “other information” column, information indicating whether or not the corresponding job is a job to which a confidentiality request is attached.

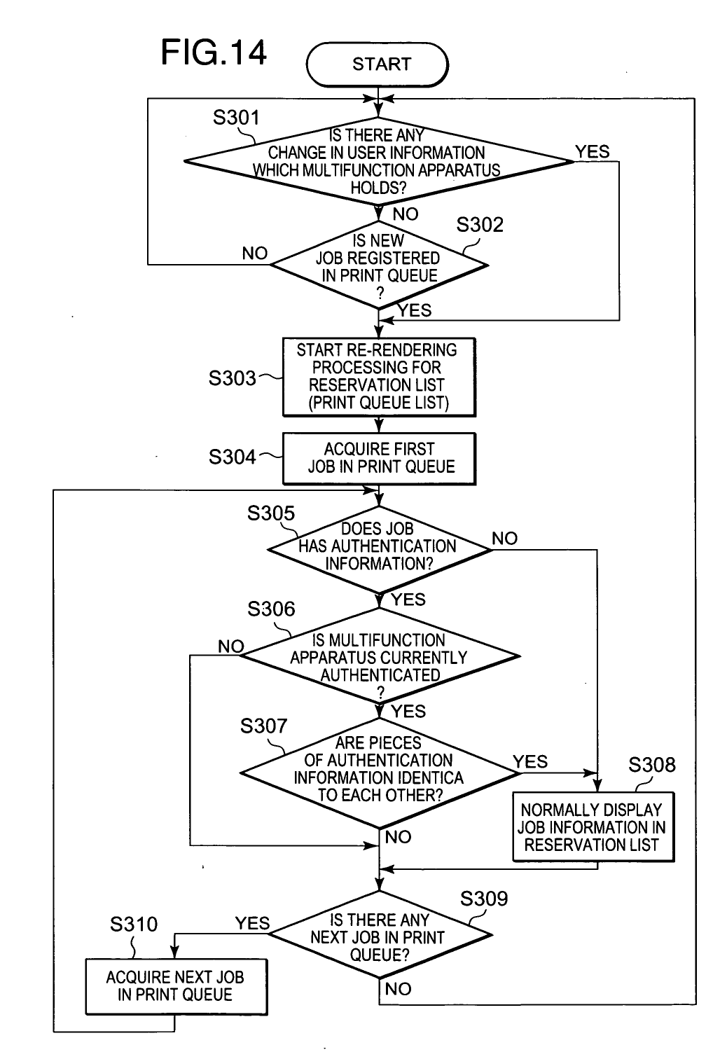

FIG. 14 is a flowchart of processing associated with display of a reservation list window. This processing functions as a job information display control section, display limiting section, and limitation cancellation section. The image printing apparatus 10 always monitors whether or not the received state of user information changes (step S301) and whether or not the registered state of the queue 31 changes (step S302). If either of the states changes (YES in step S301 or S302), the image printing apparatus 10 starts re-rendering processing for a reservation list window (step S303). The registered state changes when a new job is added to the queue 31 or a job is deleted from the queue 31 upon completion or cancellation of the execution of the job.

In re-rendering processing, the image printing apparatus 10 acquires the first job of the queue 31 (step S304) and checks whether the job is a job to which a confidentiality request is attached (step S305). If this job is a job to which a confidentiality request is attached, i.e., a job that is waiting for the reception of user information (YES in step S305), the image printing apparatus 10 checks whether the non-contact IC tag reader 18 has received user information from an ID card 7 at the current point of time (step S306).

If the non-contact IC tag reader 18 has received user information (YES in step S306), the image printing apparatus 10 checks from the user information whether the job is a job of the user (step S307). When the user information registered in association with the job is identical to the received user information, this job is recognized as a job of the user who manages it.

If it is recognized from the received user information that the job is a job of the user (YES in step S307) or the job is not a job to which a confidentiality request is attached (NO in step S305), information concerning the job is normally added to the reservation list window (step S308).

If the job is a job to which a confidentiality request is attached, and the non-contact IC tag reader 18 of the image printing apparatus 10 has not received user information from the ID card 7 at the current point of time (NO in step S306), or it is determined from received user information that the corresponding job is not a job of the user (NO in step S307), information associated with this job is not added to the reservation list window.

After this operation or job information is added to the reservation list window (step S308), the image printing apparatus 10 checks whether or not a next job is registered in the queue 31 (step S309). If a next job is registered (YES in step S309), the image printing apparatus 10 acquires the next job from the queue 31 (step S310). The flow then returns to step S305 to execute the same processing as that described above (steps S305 to S308) for this job. If no next job is registered in the queue 31 (NO in step S309), this re-rendering processing is terminated. The flow then returns to step S301 to monitor changes in the received state of user information in the registered state of a job.

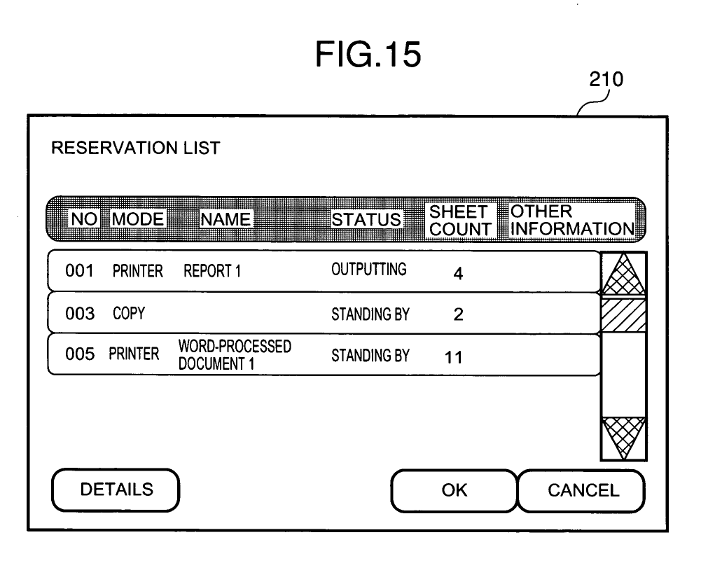

FIG. 15 shows an example of a reservation list window 210 in a case wherein there is a job to which a confidentiality request is attached, which is not a job of the user. FIG. 15 shows a state wherein both the confidential copy job of No. 002 and the confidential print job of No. 004 to which confidentiality requests are attached in the window shown in FIG. 13 are not jobs of the user, and hence display of job information is inhibited and concealed.

Such a display state occurs when the user who has requested the job of No. 002 or the job of No. 004 is not present in front of the image printing apparatus 10 (in the communicative range) while carrying his/her ID card 7. For example, such a display state occurs in a case wherein after a user issues a confidential print request to the image printing apparatus 10 through a print data transmission device 5, the user who manages the job is not present in front of the image printing apparatus 10, or in a case wherein although the user comes in front of the image printing apparatus 10, he/she moves away from the image printing apparatus 10 again because of the presence of a preceding job.

In this manner, if the user who manages a job to which a confidentiality request for confidential printing is attached is not present in front of the image printing apparatus 10, display of information concerning the job is limited. This prevents the job information of a job with high confidentiality from being displayed on a display operation section 15 of the image printing apparatus 10 while the job waits for a turn to be executed, thereby ensuring confidentiality.

In the reservation list window 210 shown in FIG. 15, no job information about the jobs of No. 002 and No. 004 is displayed. However, the user who sees the reservation list window 210 can recognize the presence of the job of No. 002 between the job of No. 001 and the job of No. 003 because “job number” displayed in list form jumps from No. 001 to No. 003. The same applies to the job of No. 004.

In the above case, display of information concerning a job with a confidentiality request which is recognized as not a job of the user is completely inhibited and limited. However, the apparatus may be configured to limit only part of display.

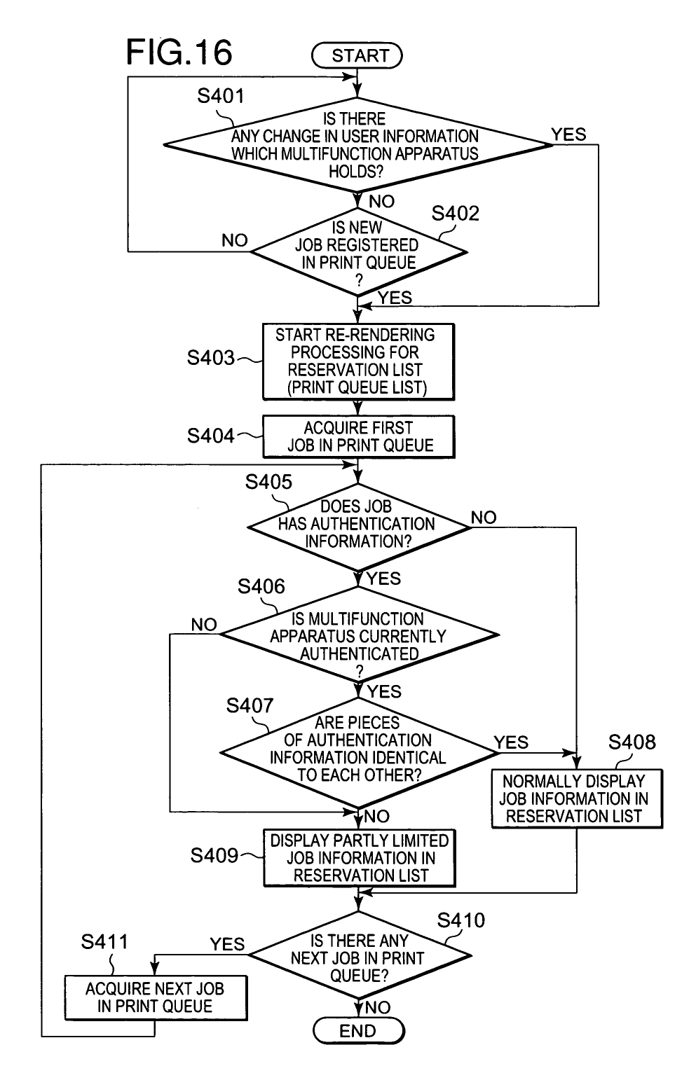

FIG. 16 is a flowchart of processing associated with display of a reservation list window in a case wherein part of display is limited. The processing shown in FIG. 16 differs from that shown in FIG. 14 in that step S409 is provided after step S407. More specifically, if a given job is a job to which a confidentiality request is attached (YES in step S405) and the non-contact IC tag reader 18 of the image printing apparatus 10 has not received user information from the ID card 7 at the current point of time (NO in step S406) or the job is recognized as not a job of the user from user information (No in step S407), information associated with the job is partly limited and added to the reservation list window (step S409).

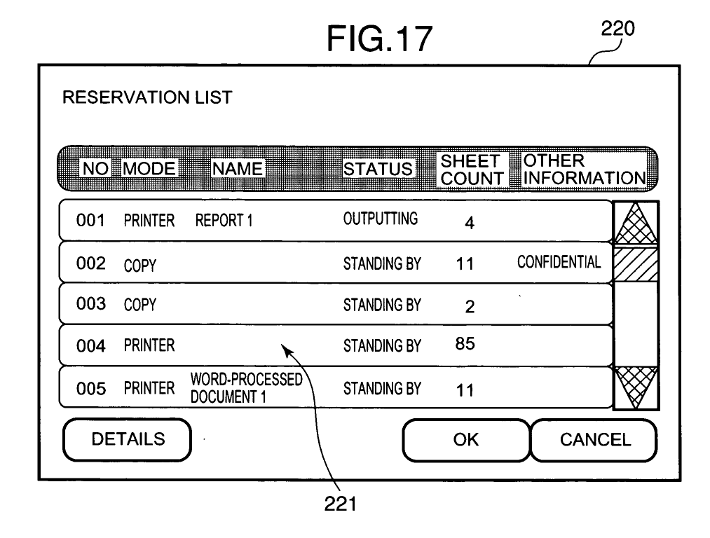

FIG. 17 shows an example of a reservation list window 220 displaying partly limited job information. In this example, in contrast to the example shown in FIG. 13, the confidential print job of No. 004 to which a confidentiality request is attached is not recognized as a job of the user; display of part of the job information is limited. Such a display state occurs when the user who has requested the job of No. 004 is not present in front of the image printing apparatus 10 while carrying the ID card 7.

Referring to FIG. 17, display of information indicating the contents of a job or information from which contents of a job can be assumed is limited. More specifically, display of information of the job of No. 004 in a “name” column 221 is inhibited to prevent the name of the file to be printed (“classified document 1” in this case) or the job name assigned by the user from being displayed. Note that when the user who has requested the job of No. 004 comes in front of the image printing apparatus 10 while carrying his/her ID card 7, re-rendering processing is executed, and job information concerning the job of No. 004 is displayed as normal contents.

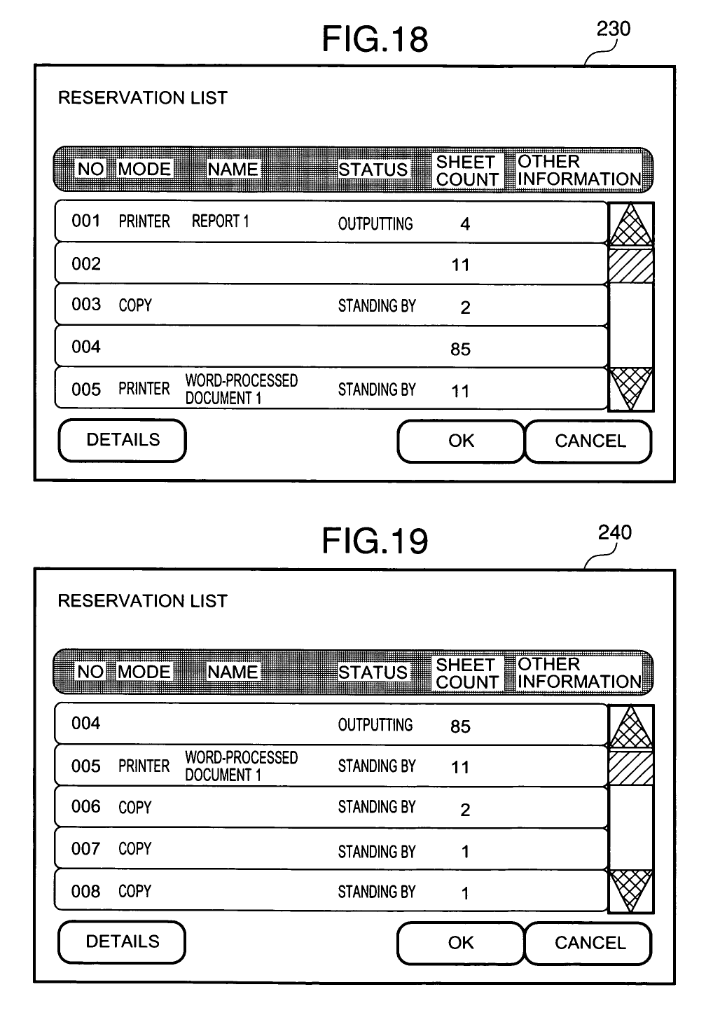

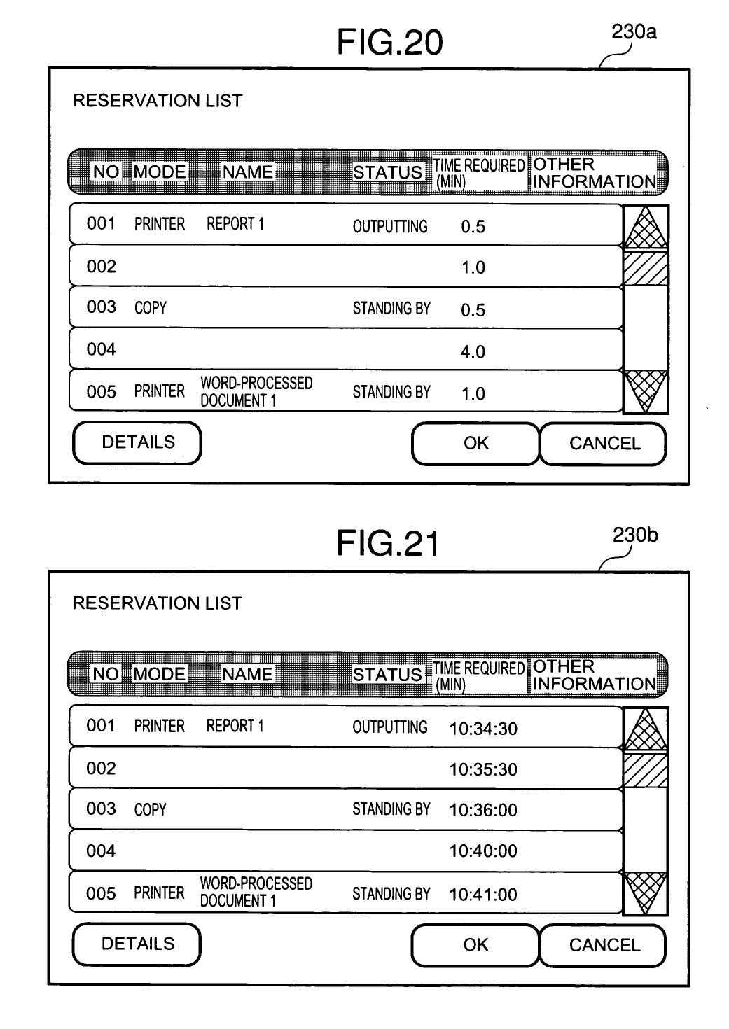

FIG. 18 shows an example of a reservation list window 230 in a case wherein display of the information of a given job is limited except for information in “sheet count” column. In this example, both the confidential copy job of No. 002 and the confidential print job of No. 004 to which confidentiality requests are attached are not recognized as jobs of the user, and display of associated information is limited. Information of each of these jobs is displayed in only the “job number” and “sheet count” columns, but display of information in other columns is limited. Displaying information in “sheet count” gives an indication of a wait time to the user who waits for the execution of a subsequent job. As indicated by reservation list windows 230a and 230b in FIGS. 20 and 21, “time required” and/or “estimated end time” may be displayed in place of “sheet count”. As an example of limiting display items, only “job number” may be displayed while display of the remaining items is inhibited. Alternatively, items whose display is limited, i.e., items to be non-displayed and/or items to be displayed, may be set by the user, as needed.

FIG. 19 shows an example of a reservation list window 240 in a case wherein while a job to which a confidentiality request is attached is subjected to printout processing, user information concerning the job ceases to be received. The execution of the confidential print job of No. 004 is started when it takes a turn to be executed and the user who is carrying the ID card 7 is present in front of the image printing apparatus 10 and recognized as the corresponding user. However, the user moves away from the image printing apparatus 10 because of, for example, a large number of sheets to be output, and the user information of the job is not currently received by the non-contact IC tag reader 18 of the image printing apparatus 10. For this reason, the user is disqualified as a user associated with display of the job, and display of information associated with the job of No. 004 is displayed even during printout processing. In this case, display of information in “mode”, “name”, and “other information” columns is inhibited.

Although the second embodiment of the present invention has been described with reference to the accompanying drawings, the practical arrangement of this apparatus is not limited to the embodiment shown in the drawings, and changes and additions within the spirit and scope of the present invention are incorporated in the invention.

Although user identification is performed by using an IC tag in the second embodiment, user identification may be performed by other methods. For example, input operation for user information may be accepted through the display operation section 15 of the image printing apparatus 10 or user information may be received from a communication terminal such as a cellular phone. In addition, operation to disqualify a given user as a user having the right to display information may be accepted by the display operation section 15.

In addition, displaying the background or characters associated with a job on which limitation of display of information concerning the job is imposed in a color different from that of other jobs makes it possible to easily inform the user that display of the job is limited.

What is claimed is:

1. An image printing apparatus comprising:
an identification section which identifies whether or not a user who requests a job is present in a predetermined range from the image printing apparatus;
a queue which stores the job and manages an execution of the job in stored order;
a job registration section which registers the job at the end of the queue; and
a job management section which suspends the start of execution of the job registered in the queue when the identification section does not recognize the presence of the user who requests the job, and permits the start of execution of the job registered in the queue when the identification section recognizes the presence of the user who manages the job.

2. An apparatus according to claim 1, wherein the identification section comprises a communication section which communicates with a non-contact communication element present in a predetermined communication range from the image printing apparatus, and the communication section performs identification on the basis of identification information acquired from the non-contact communication element.

3. An apparatus according to claim 2, wherein the non-contact communication element comprises an IC tag provided in a medium which can be moved together with the user.

4. An image printing apparatus which includes job storing section which sequentially stores image information in the order of first image information, second image information, and third image information as jobs submitted by an user, and image printing section which performs image printing operation based on the image information in the order in which the image information is stored in the storing section, comprising:
a communication section which communicates with a non-contact communication element storing a first identification information concerning an user who has the non-contact communication element;
an acquisition section which acquires the first identification information from a non-contact communication element located in a communication range of the communication section;
a determination section which determines whether or not a first user indicated by the first identification information is identical to a second user indicated by a second identification information concerning the user of the second image information based on the first identification information and the second identification information, after the image printing operation based on the first image information is completed by the image printing section, wherein the second identification information is stored in association with the second image information; and
a control section which suspends the start of the image printing operation based on the second image information when the determination section determines that the first user is not identical to the second user, and permits the start of the image printing operation based on the third image information in case the second identification information is not stored with the third image information or in case the determination section determines that the first user is identical to the second user indicated by the second identification information stored with the third image information.

5. An apparatus according to claim 4, wherein when the determination section determines, during image printing operation based on the third image information, that the first user indicated by the first identification information is identical to the second user indicated by the second identification information, the image printing operation based on the third image information is temporarily interrupted in accordance with an attribute of the third image information, and image printing operation based on the second image information is executed.

6. An apparatus according to claim 5, wherein when a postprocessing function after the image printing operation is set as the attribute, interruption of image printing operation based on the third image information is inhibited, and suspension of the start of image printing operation based on the second image information is continued.

7. An apparatus according to claim 4, wherein when image printing is completed by the image printing section, the determination section determines with respect to the suspended second image information whether the first user indicated by the first identification information is identical to the second user indicated by the second identification information, and when it is determined that the first user is identical to the second user, the control section starts image printing operation based on the second image information.

8. An apparatus according to claim 4, wherein when the determination section determines, during image printing operation based on the third image information, that the first user indicated by the first identification information is not identical to the second user indicated by the second identification information, the control section continues the image printing operation based on the third image information, and suspends the image printing operation based on the second image information.

9. An apparatus according to claim 4, wherein the communication section periodically communicates with the non-contact communication element and acquires the first identification information through the acquisition section.

10. An apparatus according to claim 4, wherein when the determination section determines, under a situation the first identification information is acquired by the acquisition section, that the first user indicated by the first identification information is identical to the second user indicated by the second identification information, display of information concerning image information stored in the job storing section is permitted.

11. An apparatus according to claim 4, wherein when the first identification information is not acquired by the acquisition section or when the determination section determines, under a situation the first identification information is acquired by the acquisition section, that the first user indicated by the first identification information is not identical to the second user indicated by the second identification information, display of information concerning image information stored in the job storing section is limited.

12. An apparatus according to claim 4, wherein when image printing based on the first image information is completed, the determination section determines with respect to the second image information, whether the first user indicated by the first identification information is identical to the second user indicated by the second identification information.

13. An apparatus according to claim 4, wherein when the second image information takes a turn to be subjected to image printing, the determination section determines with respect to the second image information, whether the first user indicated by the first identification information is identical to the second user indicated by the second identification information.

14. An apparatus according to claim 6, wherein the postprocessing function comprises one or both of a stapling process and a punching process.

15. An apparatus according to claim 4, further comprising job information display control section for displaying information concerning each job registered and stored in the job storing section in list form in stored order.

16. An apparatus according to claim 4, wherein the non-contact communication element comprises an IC tag embedded in a terminal which can be carried by a user

17. An apparatus according to claim 4, further comprising:
a display which displays job information concerning each job stored in the job storing section;
a job information display control section which controls to display the job information in list form in an order in which the image information is stored in the job storing section; and
a display limiting section which limits display of information based on the job information, when the determination section determines that the first user indicated by the first identification information is not identical to the second user indicated by the second identification information.

18. An apparatus according to claim 17, further comprising:
a limitation cancellation section which cancels the limitation by the display limiting section, when the determination section determines that the first user indicated by the first identification information is not identical to the second user indicated by the second identification information.

19. An apparatus according to claim 18, wherein when the determination section determines that the first identification information and the second identification information is not identical, display of information concerning image information stored in the job storing section is inhibited by the display limiting section.

20. An apparatus according to claim 17, wherein operation of the determination section is inhibited while no first identification information is acquired from the non-contact communication element by the acquisition section.

21. An apparatus according to claim 17, wherein the communication section periodically communicates with the non-contact communication element and acquires the first identification information by the acquisition section.

22. An apparatus according to claim 17, wherein when the determination section determines, under a situation the first identification information is acquired by the acquisition section, that the first user indicated by the first identification information is identical to the second user indicated by the second identification information, display of information concerning image information stored in the job storing section is permitted.

23. An apparatus according to claim 17, wherein when the first identification information is not acquired by the acquisition section or when the determination section determines, under a situation the first identification information is acquired by the acquisition section, that the first user indicated by the first identification information is not identical to the second user indicated by the second identification information, display of information concerning image information stored in the job storing section is limited.

24. An apparatus according to claim 17, wherein the display limiting section causes at least part of information concerning image information to be non-displayed.

25. An apparatus according to claim 17, wherein the display limiting section causes a part of information concerning image information to be non-displayed, and also causes another part of the information thereof to be displayed.

26. An apparatus according to claim 25, wherein an item display of which is permitted by the display limiting section comprises information concerning a priority of a job.

27. An apparatus according to claim 25, wherein an item display of which is permitted by the display limiting section comprises information associated with an attribute of a job.

28. An apparatus according to claim 25, wherein an item display of which is permitted by the display limiting section comprises information associated with a status of a job.

29. An apparatus according to claim 25, wherein an item display of which is permitted by the display limiting section comprises information concerning a user of a job.

30. An apparatus according to claim 25, wherein an item display of which is permitted by the display limiting section comprises information concerning the required number of sheets for a job.

31. An apparatus according to claim 25, wherein an item display of which is permitted by the display limiting section comprises information concerning a time required for a job.

32. An apparatus according to claim 17, further comprising an image reading section, wherein when image information read by the image reading section is to be stored in the job storing section, user information acquired by the acquisition section is stored as the second identification information in the job storing section in association with the read image information.

33. An apparatus according to claim 17, further comprising an image information acquisition section which acquires image information from an external terminal, wherein the image information acquisition section acquires the second identification information concerning the external terminal, and stores the image information and the second identification information in the job storing section in association with each other.

34. A apparatus according to claim 17, wherein the non-contact communication element comprises an IC tag embedded in a terminal which can be carried by a user.

35. A job processing method in an image printing apparatus which includes job storing section which sequentially stores image information in the order of first image information, second image information, and third image information as jobs submitted by an user, and image printing section which performs image printing operation based on the image information in the order in which the image information is stored in the job storing section, comprising the steps of:
communicating with a non-contact communication element storing a first identification information concerning an user who has the non-contact communication element;
acquiring the first identification information from the non-contact communication element located in a communication range of the image printing apparatus;
storing the acquired first identification information;
sequentially obtaining a second identification information concerning an user of the image information;
after image printing operation based on the first image information is completed, determining whether or not a first user indicated by the first identification information is identical to a second user indicated by the second identification information; and
suspending the start of the image printing operation based on the second image information when it is determined that the first user indicated is not identical to the second user in the determining step, and permitting the start of the image printing operation based on the third image information in case the second identification information is not stored with the third image information or in case it is determined that the first user is identical to the second user indicated by the second identification information stored with the third image information in the determining step.

36. The method of claim 35, wherein, during image printing operation based on the third image information, when it is determined that the first user indicated by the first identification information is not identical to the second user indicated by the second identification information, the image printing operation based on the third image information is continued, and the image printing operation based on the second image information is suspended.

37. The method of claim 35, wherein when image printing based on the first image information is completed, with respect to the second image information, it is determined whether the first user indicated by the first identification information is identical to the second user indicated by the second identification information.

38. The method of claim 37, wherein when it is determined that the first user indicated by the first identification information is identical to the second user indicated by the second identification information, the image printing operation based on the second image information is started.

39. The method of claim 35, wherein when the second image information takes a turn to be subjected to image printing, with respect to the second image information, it is determined whether the first user indicated by the first identification information is identical to the second user indicated by the second identification information.

40. The method of claim 39, wherein when it is determined that the first user indicated by the first identification information is identical to the second user indicated by the second identification information, the image printing operation based on the second image information is started.

41. The method of claim 35, further comprising the steps of:
displaying job information concerning each job stored in the job storing section;
controlling to display the job information in list form in an order in which the image information is stored in the job storing section; and
limiting display of information based on the job information, when it is determined that the first user indicated by the first identification information is not identical to the second user indicated by the second identification information.

42. The method of claim 41, wherein a part of information concerning image information is not displayed, and another part of the information thereof is displayed.

43. The method of claim 42, wherein an item display of which is permitted by the display limiting section comprises information concerning a priority of a job.

44. The method of claim 42, wherein an item display of which is permitted by the display limiting section comprises information associated with an attribute of a job.

45. The method of claim 42, wherein an item display of which is permitted by the display limiting section comprises information associated with a status of a job.

46. The method of claim 42, wherein an item display of which is permitted by the display limiting section comprises information concerning a user of a job.

47. The method of claim 42, wherein an item display of which is permitted by the display limiting section comprises information concerning the required number of sheets for a job.

48. The method of claim 42, wherein an item display of which is permitted by the display limiting section comprises information concerning a time required for a job.

49. The method of claim 41, further comprising the steps of:
reading an image of a document to obtain an image information, wherein the image information is stored in associated with the first identification information in reading operation as the second identification information.

50. The method of claim 41, further comprising the step of:
acquiring an image information from an external terminal, wherein the image information is stored in associated with the second identification information concerning the external terminal.
